(19) United States
(12) Patent Application Publication
(10) Pub. No.: US 2006/0237407 A1
(43) Pub. Date: Oct. 26, 2006

(54) Medical devices having laser brazed joints

(76) Inventors: Anh Viet Nguyen, Eden Prairie, MN (US); Samuel Robaina, Maple Grove, MN (US)

Correspondence Address: MAYER & WILLIAMS PC, 251 NORTH AVENUE WEST, 2ND FLOOR, WESTFIELD, NJ, 07090, US

(21) Appl. No.: 11/113,768

(22) Filed: Apr. 25, 2005

(51) Int. Cl. B23K 1/005

(52) U.S. Cl. 219/121.85; 219/85.13

(57) ABSTRACT

A method is provided for forming a brazed joint between first and second elements of a medical device such as a stent. The method begins by forming a joint by positioning the first element with respect to the second element. A filler material is applied to the joint. An electromagnetic beam of energy is applied to the joint to at least partially melt the filler material.

### FIELD OF THE INVENTION

The present invention relates generally to welding techniques, and more specifically to laser welding techniques used to secure joints in medical devices such as stents.

### BACKGROUND OF THE INVENTION

Stents and stent delivery devices are employed in a number of medical procedures and as such their structure and function are well known. Stents are used in a wide array of bodily vessels including coronary arteries, renal arteries, peripheral arteries including iliac arteries, arteries of the neck and cerebral arteries as well as in other body structures, including but not limited to arteries, veins, biliary ducts, urethras, fallopian tubes, bronchial tubes, the trachea, the esophagus and the prostate.

Stents are typically cylindrical, radially expandable prostheses introduced via a catheter assembly into a lumen of a body vessel in a configuration having a generally reduced diameter, i.e. in a crimped or unexpanded state, and are then expanded to the diameter of the vessel. In their expanded state, stents support or reinforce sections of vessel walls, for example a blood vessel, which have collapsed, are partially occluded, blocked, weakened, or dilated, and maintain them in an open unobstructed state. To be effective, the stent should be relatively flexible along its length so as to facilitate delivery through torturous body lumens, and yet stiff and stable enough when radially expanded to maintain the blood vessel or artery open. Such stents may include a plurality of axial bends or crowns adjoined together by a plurality of struts so as to form a plurality of U-shaped members coupled together to form a serpentine pattern.

Stents may be formed using any of a number of different methods. One such method involves forming segments from rings, welding or otherwise forming the stent to a desired configuration, and compressing the stent to an unexpanded diameter. Another such method involves machining tubular or solid stock material into bands and then deforming the bands to a desired configuration. While such structures can be made many ways, one low cost method is to cut a thin-walled tubular member of a biocompatible material (e.g. stainless steel, titanium, tantalum, super-elastic nickel-titanium alloys, high-strength thermoplastic polymers, etc.) to remove portions of the tubing in a desired pattern, the remaining portions of the metallic tubing forming the stent. Since the diameter of the stent is very small, the tubing from which it is made must likewise have a small diameter. For example, stents may have an outer diameter of about 0.045 inch in their unexpanded configuration and can be expanded to an outer diameter of about 0.1 inch or more. The wall thickness of the stent may be approximately 0.003 inch. In part because of their small dimensions, manufacturing techniques that are employed in the aforementioned processes often involve laser welding and laser cutting.

One problem that arises with the use of laser welding and laser cutting techniques is that the stents must be formed from only a single material (in the case of laser cutting) or from materials that are chemically compatable and have relatively similar melting temperatures (in the case of laser welding).

### SUMMARY OF THE INVENTION

In accordance with the present invention, a method is provided for forming a brazed joint between first and second elements of a medical device. The method begins by forming a joint by positioning the first element with respect to the second element. A filler material is applied to the joint. An electromagnetic beam of energy is applied to the joint to at least partially melt the filler material.

In accordance with one aspect of the invention, the electromagnetic beam is a laser beam.

In accordance with another aspect of the invention, the laser beam is a pulsed beam.

In accordance with another aspect of the invention, the laser beam is a CW (Continuous Wave) laser beam.

In accordance with another aspect of the invention, the medical device is a stent and at least one of the first and second elements are stent struts.

In accordance with another aspect of the invention, the first and second materials comprise a common material.

In accordance with another aspect of the invention, the first and second materials comprise different materials.

In accordance with another aspect of the invention, the first and second materials are metallic materials.

In accordance with another aspect of the invention, at least one of the first and second materials is stainless steel.

In accordance with another aspect of the invention, at least one of the first and second materials is Nitinol.

In accordance with another aspect of the invention, the filler material is a paste.

In accordance with another aspect of the invention, the laser beam is generated by a CO₂ laser.

In accordance with another aspect of the invention, the laser beam has a wavelength of about 10600 nm.

In accordance with another aspect of the invention, the laser beam is generated by a Nd:YAG laser.

In accordance with another aspect of the invention, the laser beam has a wavelength of about 1064 nm.

In accordance with another aspect of the invention, the electromagnetic beam is generated by a laser diode.

In accordance with another aspect of the invention, the electromagnetic beam has a wavelength in a range of about 750 nm to 1000 nm.

In accordance with another aspect of the invention, the laser beam is focused onto the joint.

In accordance with another aspect of the invention, the laser beam is overfocused or underfocused on the joint.

In accordance with another aspect of the invention, the first element and the second element are positioned so that they are in contact with one another.

In accordance with another aspect of the invention, the first and second elements are positioned so that there is a gap therebetween.

In accordance with another aspect of the invention, the gap is between about 0.0001 and 0.0500 inches in length.

### BRIEF DESCRIPTION OF THE DRAWINGS

FIG. 1 shows in fragment a portion of an exemplary stent having joints that may be brazed in accordance with the present invention.

FIG. 2 shows a fragmentary portion of another exemplary stent.

FIG. 3 shows a perspective view of the stent depicted in FIG. 2.

FIG. 4 is a schematic representation of one example of an apparatus for brazing joints in the manufacture of a medical device in accordance with the present invention.

FIG. 5(a) shows a joint that may undergo brazing in accordance with the present invention and FIG. 5(b) shows the joint after it has been brazed.

### DETAILED DESCRIPTION

The present invention applies laser brazing techniques to secure joints in a wide variety of medical devices including, without limitation, stents, guidewires and the like. For purposes of illustration only and not as a limitation on the invention, the present invention will be described in terms of stents formed from a cylindrical metal mesh that can expand when pressure is internally applied. Examples of such stents, described below, are shown in FIGS. 1-3. Of course, the present invention is equally applicable to a wide variety of other types of stents including, without limitation, various balloon-expandable and self-expanding stents, as well as those formed from a wire, sheet or tube into spiral, coil or woven geometries, either open or closed cell.

Having reference to FIG. 1, there is shown in fragment a portion of a stent 10 of closed cell geometry in schematic form. This stent is formed from interconnected deformable wires or struts 11, to form a mesh that is rolled into a cylindrical configuration to form the completed stent 9. The individual struts formed by wire 11 may be manufactured by laser cutting from tubular stock of an appropriate diameter. Conventionally, the struts 11 are welded together at the joints defined by their points of intersection. By way of example, the struts typically have a width in the range of about 0.00025-0.002 inches and a thickness in the range of about 0.00025-0.004 inches

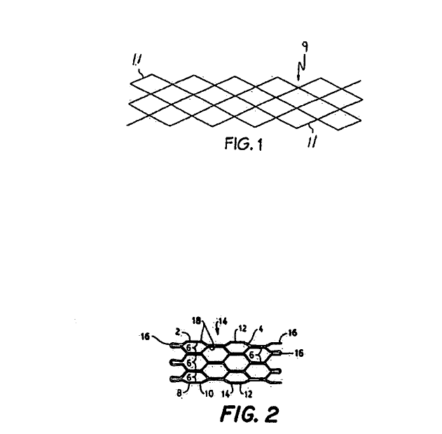

FIG. 2 shows a fragmentary portion of another exemplary stent to which the present invention may be applied. FIG. 3 shows a perspective view of the same stent when it is shaped into a tubular configuration. The illustrative stent is shown in a first condition in which the frame 2 is expanded, relatively rigid, and substantially tubular in configuration. The stent is formed from a single wire 4 having ends 8, 10 that are disposed in one of the straight portions 6 that define a joint, such that there are no exposed wire free ends, disposed within or extending from the frame 2. Conventionally, the abutting and elongated straight portions 6 of the wire 4 are welded together to securely join the wire portions 6 together. The wire 4 may have a circular or non-circular cross-section. Segments of the wire 4 only abut at the straight portions 6 and do not cross at any point. Accordingly, the frame walls, that is, walls 12 have a thickness equal to the diameter of the wire 4. The stent includes a body portion 14 and finger portions 16 extending generally axially from one or both ends of the body portion 14. The finger portions 16 facilitate a gradual reduction in the radially outwardly extending pressure exerted by the stent on the wall of a vascular passageway in which the stent is located. Such gradual reduction of pressure facilitates acceptance of the stent by the passageway and reduces deleterious reactions by the passageway wall to the presence of the stent. The tubular body portion 14 comprises a mesh formed by the wire 4, the mesh comprising a plurality of interconnected cells 18 of a polygonal configuration when viewed in plan, providing straight sides to form the aforementioned straight portions 6. As shown, the polygonal cells 18 may have a hexagonal configuration, which readily provides expansion and rigidity characteristics desirable in the structure and operation of the device.

The aforementioned stents may be made from a metallic material such as stainless steel or, alternatively, an alloy of nickel and titanium, which provides the stent with a thermal memory. The unique characteristic of this alloy, known generally as “Nitinol,” is its thermally triggered shape memory, which allows a stent constructed of the alloy to be cooled and thereby softened for loading into a catheter in a relatively compressed and elongated state, and regain the memoried shape when warmed to a selected temperature, such as human body temperature. Other materials that may be employed include tantalum, platinum alloys, niobium alloys and cobalt alloys. In some cases the stent may be formed from two or more different materials. For example, one section of the stent may comprise a flexible material such as stainless steel or a shape memory alloy such as Nitinol, while another section may be formed of a more rigid, radiopaque material such as gold, tantalum, platinum, and so forth, or alloys thereof. Accordingly, joints may need to be secured that are formed from two different materials that have significantly different properties, thereby making it difficult to weld them together. As discussed below, laser brazing techniques may be particularly advantageous when applied to such joints.

In brazing generally, metallic materials are joined using a filler material that will flow into the narrow gap between the materials and solidify. Heat is applied to melt the filler material. In laser brazing, the necessary heat is generated by converting collimated high-energy electromagnetic radiation as it impinges on the workpiece. The absorbed portion of the laser radiation heats the workpiece to brazing temperature and melts the filler material so that it can wet the surfaces to be joined.

One advantage arising from the use of laser brazing is that a focused laser beam can provide a highly localized heat source to form a metallurgical bond without affecting the individual bulk components to be joined. In this way laser brazing offers the potential to reduce damage to the individual components by limiting the thermal degradation to regions adjacent to the joint. Another advantage is that a greater variety of dissimilar materials can be joined in comparison to other techniques such as welding. For example, dissimilar metal alloys such as stainless steel and Nitinol can be joined by this technique. Of course, the laser brazing technique may be applied to joints from similar or identical materials as we as dissimilar material.

In comparison to brazing techniques that use more conventional heating sources, laser brazing provides a number of advantages when applied to medical devices such as stents. For example, higher yields can be achieved because the laser's energy output can be controlled and maintained with precision, which makes the temperature of the filler material more controllable and stable as it approaches its melting temperature. In addition, because laser brazing uses a non-contact heat source, contamination that might otherwise arise during the joining process can be avoided.

In selecting an appropriate filler material for securing medical device joints, several criteria should be considered. In particular, the filler material should be biocompatible, possess a low or high melt temperature, possess strong bonding properties, be free flowing and provide corrosion resistance. The filler material may be in the form of a paste, solid foil, powder and the like. The joints to be brazed may be coated with the filler material in any conventional manner such as by spraying, sprinkling, scattering or brushing. One example of a suitable filler material that may be employed when joining stainless steel and Nitinol materials is a BAg-7 brazing paste.

The interaction between the laser beam and surfaces of the joint is controlled primarily by the incident power density and the available interaction time. In some cases it may be advantageous to employ a relatively high power density so that the filler material is melted very rapidly, before it has enough time to heat up a large heat affected zone, which should generally be avoided. Other parameters that may be used to control the amount of energy that is delivered include the frequency of laser modulations and the pulse width. In any case, these parameters are selected so that the filler material can be melted or at least partially melted while keeping the size of the heat affected zone relatively small so as to not adversely affect the bulk materials being joined. The laser beam may be applied directly to the filler material and/or the bulk material immediately adjacent to the joint. If the laser beam is applied to bulk material, thermal conductivity heats the joint and the filler material to the brazing temperature. Factors that will determine the temperature distribution throughout the joint are the geometry of the joint, the thermal conductivity of the materials and the coupling coefficient of the laser beam with the materials.

Any appropriate source of electromagnetic energy such as a laser that is capable of melting or partially melting the filler material may be employed in the present invention. For example Nd:YAG or CO2 lasers operating at a wavelength of, e.g., 1064 nm-10600 nm may be employed. Alternatively, laser diodes such as those operating at wavelengths between about 750 to 1000 nm may be employed.

As previously mentioned, one factor affecting the thermal profile of the joint is the intensity distribution of the laser beam. Unlike laser welding or cutting, a wider beam with uniform energy distribution is generally desired to perform laser brazing. This can be readily accomplished by defocusing (either by overfocusing or underfocusing) the laser beam so that its focal point is located in a plane other than the plane of the surfaces to be joined. Alternatively, a laser beam of appropriate dimension can be achieved by altering the mode structure of the laser beam in the resonator or by adjusting the working distance between the optics and workpiece to obtain a particular beam size needed for creating a given joint dimension.

Referring to FIG. 4, there is shown a schematic representation of one example of an apparatus for brazing joints in the manufacture of a stent using a laser as the thermal source. The apparatus includes laser 40, machine-controlled apparatus 44 that includes a fixture element such as a rotary chuck (not shown), X/Y table 42, and controller 46. The stent 48 may be fabricated about a mandrel (not shown) having a substantially circular external surface and a cross-sectional diameter substantially equal to or less than the internal diameter of the stent to be fabricated. In operation, the stent 48 (or individual components thereof such as the struts to be joined) is placed in the fixture element of the machine-controlled apparatus 40 such that the controller 46 positions the joint relative to the laser 40. The process is fully automated except for the loading and unloading of the stent and the application of the filling material. X/Y table moves the joint axially relative to laser 40 under the control of controller 46.

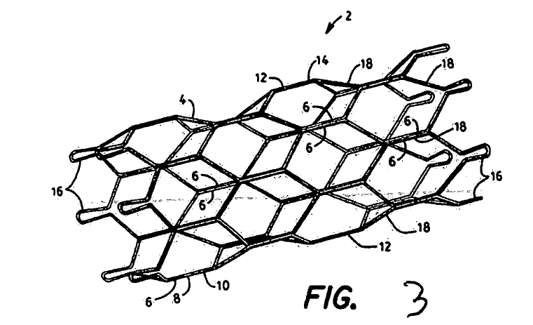

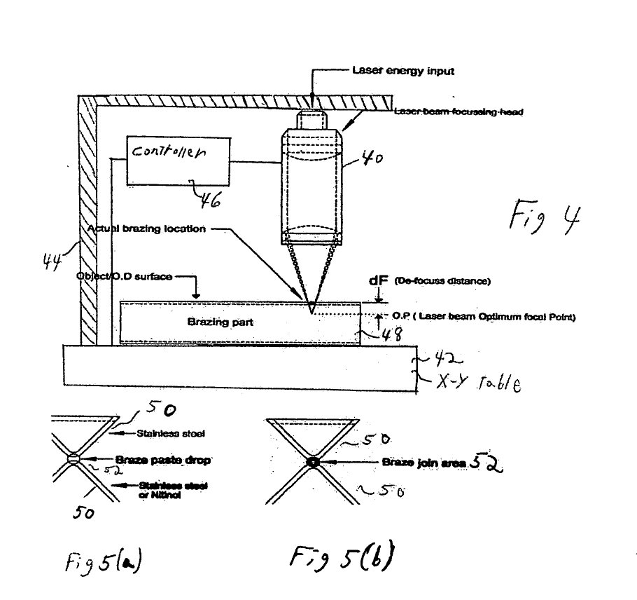

FIG. 5(a) shows a single joint 52 formed between the struts 50 of a stent of the type seen in FIGS. 1-3. The struts 50 are placed in contact or close proximity to one another. If in close proximity, the gap between the struts 50 will typically be in the range of about 0.0001 to 0.0500 inches. A filler material of paste is also shown filling the gap. In FIG. 5(b), the paste has been melted by the laser and allowed to cool to establish a secure bond between the struts 50.

1. A method of forming a brazed joint between first and second elements of a medical device, comprising:
forming a joint by positioning the first element with respect to the second element;
applying a filler material to the joint;
applying an electromagnetic beam of energy to the joint to at least partially melt the filler material.

2. The method of claim 1 wherein said electromagnetic beam is a laser beam.

3. The method of claim 2 further comprising the step of pulsing the laser beam.

4. The method of claim 2 wherein the laser beam is a CW (Continuous Wave) laser beam.

5. The method of claim 1 wherein the medical device is a stent and at least one of said first and second elements are stent struts.

6. The method of claim 1 wherein the first and second materials comprise a common material.

7. The method of claim 1 wherein the first and second materials comprise different materials.

8. The method of claim 1 wherein the first and second materials are metallic materials.

9. The method of claim 1 wherein at least one of the first and second materials is stainless steel.

10. The method of claim 1 wherein at least one of the first and second materials is Nitinol.

11. The method of claim 1 wherein the filler material is a paste.

12. The method of claim 2 wherein the laser beam is generated by a CO₂ laser.

13. The method of claim 12 wherein the laser beam has a wavelength of about 10600 nm.

14. The method of claim 2 wherein the laser beam is generated by a Nd:YAG laser.

15. The method of claim 14 wherein the laser beam has a wavelength of about 1064 nm.

16. The method of claim 1 wherein said electromagnetic beam is generated by a laser diode.

17. The method of claim 16 wherein the electromagnetic beam has a wavelength in a range of about 750 nm to 1000 nm.

18. The method of claim 2 further comprising the step of focusing the laser beam on the joint.

19. The method of claim 2 further comprising the step of overfocusing or underfocusing the laser beam on the joint.

20. The method of claim 1 wherein the first element and the second element are positioned so that they are in contact with one another.

21. The method of claim 1 wherein the first and second elements are positioned so that there is a gap therebetween.

22. The method of claim 21 wherein the gap is between about 0.0001 and 0.0500 inches in length.
